(19) United States
(12) Patent Application Publication
(10) Pub. No.: US 2024/0427588 A1
(43) Pub. Date: Dec. 26, 2024

(54) FIRMWARE UPDATE WITH LOGICAL ADDRESS REMAPPING

(71) Applicant: TEXAS INSTRUMENTS INCORPORATED, Dallas, TX (US)

(72) Inventors: Yaron Alpert, Hod-Hasharon (IL); Yoav Ben-Yehezkel, Netanya (IL); Barak Cherches, Ramat-Hakovesh (IL)

(21) Appl. No.: 18/340,993

(22) Filed: Jun. 26, 2023

(51) Int. Cl. G06F 8/65

(52) U.S. Cl. CPC G06F 8/65

(57) ABSTRACT

A system includes memory which has a first resource at a first physical address space that includes a first physical address, and a second resource at a second physical address space that includes a second physical address. A memory mapper is coupled to the memory. The memory mapper is configured to convert logical addresses to physical addresses. A processor is coupled to the memory mapper. The processor is configured to execute the first resource from a first logical address mapped by the memory mapper to the first physical address. While executing a firmware update resource, the processor can remap the first logical address to the second physical address using the memory mapper and then execute the second resource from the first logical address.

### BACKGROUND

Many systems have a processor that executes a resource such as firmware. It may be desirable to update all or a portion of the device's resources. Some resource update processes are reset-based processes in which the device is reset to complete the switch-over from the currently executing copy of the resource to the updated copy of the resource. During a reset, the previous state (e.g., configuration parameters) may be saved, the previous version of the resource ceases execution, a bootloader may initiate execution of the new version of the resource, and the previously saved state may be used to reconfigure the device for continued operation. During the reset process, because the device ceases execution of the previous version of the resource, the device is generally unusable to perform the functionality that it would otherwise perform if the resource had continued to be executed.

### SUMMARY

In one example, a system includes memory which has a first resource at a first physical address space that includes a first physical address, and a second resource at a second physical address space that includes a second physical address. A memory mapper is coupled to the memory. The memory mapper is configured to convert logical addresses to physical addresses. A processor is coupled to the memory mapper. The processor is configured to execute the first resource from a first logical address mapped by the memory mapper to the first physical address. While executing a firmware update resource, the processor can remap the first logical address to the second physical address using the memory mapper and then execute the second resource from the first logical address.

In another example, an integrated circuit includes a memory mapper configured to convert logical addresses to physical addresses. A processor is coupled to the memory mapper. The processor configured to execute a first resource from a first logical address mapped by the memory mapper to a first physical address of a memory. Further, while executing a firmware update resource, the processor can remap the first logical address to a second physical address of a second resource using the memory mapper and execute the second resource from the first logical address.

In another example, a method includes executing, by a processor, a first resource from a first logical address mapped to a first physical address of a memory. While executing a firmware update resource by the processor, the method includes remapping the first logical address to a second physical address of the memory. The method also includes executing, by the processor, a second resource from the first logical address.

### BRIEF DESCRIPTION OF THE DRAWINGS

FIG. 1 is a schematic diagram of an example integrated circuit including a memory mapper, in accordance with an example.

FIG. 2 is a schematic diagram of the memory mapper, in accordance with an example.

FIGS. 3 and 4 are example logical-to-physical address mappings before and after the logical address space of an active resource stored at a physical address space of the active resource is remapped to a physical address of a candidate resource, in accordance with an example.

FIG. 5 is a timing diagram illustrating the switch-over of a logical address space mapping from one physical address space to another physical address space, in accordance with an example.

FIGS. 6 and 7 are example logical-to-physical address mappings before and after the logical address space of multiple active resources are remapped to physical address spaces of a candidate resources, in accordance with an example.

FIGS. 8-10 are example logical-to-physical address mappings illustrating sequentially remapping the logical address space of each of multiple active resources to physical address spaces of respective candidate resources, in accordance with an example.

FIG. 11 is a flow chart showing an example method for switching over from execution of a first resource to a second resource, in accordance with an example.

FIG. 12 is a flow chart showing an example method which includes one or more checks on the candidate resource while remapping the logical address space of an active resource to the candidate resource, in accordance with an example.

### DETAILED DESCRIPTION

The same reference numbers or other reference designators are used in the drawings to designate the same or similar (either by function and/or structure) features, unless otherwise indicated.

The making and using of the examples disclosed are discussed in detail below. It should be appreciated, however, that the present disclosure provides many applicable inventive concepts that can be embodied in a wide variety of specific contexts. The specific examples discussed are merely illustrative of specific ways to make and use the invention(s), and do not limit the scope of the invention(s).

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” or “an example” in this description indicate that a particular configuration, structure or feature described in relation to the embodiment is included in at least one embodiment. Consequently, phrases such as “in one example” that may appear at different points of the present description do not necessarily refer exactly to the same embodiment. Furthermore, specific formations, structures or features may be combined in any appropriate manner in one or more embodiments.

The example system described herein can implement a resource update process (e.g., a firmware update) that switches from a currently executing (e.g., by a processor) version of a resource (referred to as the “active” resource) to a new version of the resource (the “candidate” resource). Relative to the active resource, the candidate resource may provide improved performance, fix an error, etc. In another example, the system may implement redundancy including identical copies of the same resource, and, if the active resource experiences an unexpected behavior, the switch-over may occur from the active resource to the identical candidate resource.

Some conventional systems require a cold start or a warm start to implement a switch-over from an active resource to a candidate resource. A cold start includes a reset of the entire system in which all state information about the system is lost, e.g., similar to a re-boot of a personal computer. A warm start may not include a system reset but does include a reset of one or more of the components or subsystems of the system to finalize the switchover from the active resource to the candidate resource. In either case-cold start or warm start because a reset is performed, the system expends clock cycles updating its internal configurations (e.g., pointers, security parameters, etc.) to transition back to its full operating state thereby possibly rendering the system unusable until the system is back at its operating state.

As described herein, a system performs a resource update (a switchover from an active resource to a candidate resource) without any type of reset. For example, in some examples, system or subsystem/component resets are not needed to be performed during the live resource update, thereby permitting the system to continue performing its intended functionality. The resource update may be a “live” resource update (e.g., a live firmware update) in which, while the system continues to operate, one or more of the active resources is switched over to a corresponding candidate resource (e.g., an active firmware is switched over to a new version of the firmware). Because a reset is not performed, the reset-less resource update process (e.g., reset-less firmware update) described herein can implement a switch-over from the active resource to the candidate resource, e.g., within one clock cycle of a clock used by a processor to execute instructions, which may be advantageous for many systems including high-availability systems (e.g., systems that should continue operating without any significant interruptions).

As used herein, the term “resource” refers to executable or non-executable resources. An executable resource may include, for example, any type of machine instructions that can be executed by a processor, such as software or firmware. A non-executable resource may include, for example, peripheral devices, interfaces, hardware accelerators, etc.

Executable resources of a system are stored at physical addresses of memory but may be accessed instead using logical addresses (also referred to as “virtual” addresses). A resource may be accessed at a physical address space using a corresponding logical address space. A physical address space may include a range of physical addresses starting at a first physical address. Similarly, a logical address space may include a range of logical addresses starting at a first logical address.

In one example of the resource update process, the system remaps the logical address space associated with the active resource from the physical address space at which the active resource is stored in memory or is accessible to a different physical address space at which the candidate resource is stored or is accessible. In some examples, remapping the logical address space may include remapping the logical address of the first instruction of the resource to the first physical address of a different physical address space. After the remapping, access to the candidate resource (which is now the active resource) may include continuing to use the same logical addresses associated with the former active resource (now an inactive resource or a candidate resource). In some examples, the physical address space at which the previous active resource (now non-active) is stored can be freed (e.g., by the operating system) for use in storing other resources and/or data. In another example, access to the physical address space at which the previous active resource (now non-active) is stored is blocked thereby preventing, for example, malicious code from being stored therein. Blocking access to the physical address space may be implemented by not remapping that particular physical address space to another logical address space.

Further, the process for updating the resource may include updating all or a portion of the resources executing on a processor within the device. For example, the system may include or have access to multiple individually executable functions, each function being a resource. The machine instructions that implement any one or more of the functions can be updated.

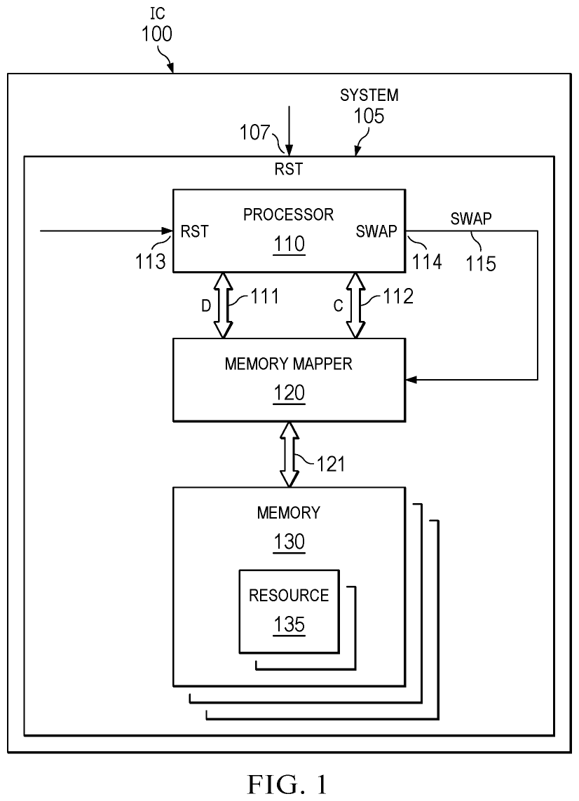

FIG. 1 is a diagram of an example integrated circuit (IC) 100. IC 100 includes a system 105 having a processor 110, a memory mapper 120, and memory 130. System 105 includes a reset (RST) input 107. When a reset signal is asserted to the RST input 107, system 105 performs a reset of the entire system, which causes system 105 to transition to an initialization state. The IC 100 may include additional components as well. Memory mapper 120 is coupled between processor 110 and memory 130. In the example of FIG. 1, processor 110 is coupled to memory mapper 120 by a data (D) bus 111 and a code (C) bus 112. In another example, processor 110 can be coupled to memory mapper 120 by a unitary bus (e.g., a bus in which data and code are on the same bus). In one example, processor 110 can send a read command on the code bus 112 in one cycle of a clock used by processor 110 to execute instructions, and the read data may be returned on the data bus 111 in a subsequent clock cycle. For a write command, processor 110 may send a write command on the code bus 112 in one clock cycle and place the write data on the data bus 111 in a subsequent clock cycle. Memory mapper 120 is coupled to memory 130 by a bus 121. Bus 121 includes both data and code in this example but can be implemented as separate data and memory busses in other examples.

Processor 110 may include a single processor or multiple processors. Unless specified otherwise, any reference to a resource being executed or a function being performed by a processor broadly includes the resource being executed/accessed or the function performed by a single processor or distributed across multiple processors. In the example of FIG. 1, processor 110 includes a RST input 113 and a SWAP output 114. SWAP output 114 is coupled to memory mapper 120. When a reset signal (which may be the same as or different than the reset signal provided to the system's RST input 107) is asserted to the processor's RST input 113, the processor 110 (or a portion of processor 110) resets to an initialization state. Processor 110 may generate a SWAP signal 115 (whose use is described below) at its SWAP output 114. In another example, the SWAP signal may be communicated to memory mapper 120 via a bus (e.g., the data bus 111 and/or code bus 112). In some examples, the state of the SWAP signal 115 may be latched and stored in an internal register of memory mapper 120.

Memory 130 includes one or more memory devices. Memory 130 may include any type of volatile storage devices such as random-access memory (RAM) (e.g., static RAM, dynamic RAM, etc.). Memory 130 may also or alternatively include non-volatile storage devices such as electrically-erasable programmable read-only memory (EEPROM), flash memory, etc.

Memory 130 may include resources 135 that are executable or accessible by processor 130. In the example of FIG. 1, memory 130 is included on IC 100, and thus resources 135 are executed from memory internal to the IC. In another example, some or all of memory 130 is external to IC 100, and thus some or all of the resources 135 are stored in external memory. As external memory, memory 130 can be coupled directly to IC 100 or may be coupled to IC 100 through one or more local and/or wide area networks. Resources 135 may include a main system resource (e.g., an operating system) and one or more executable function resources. Each function resource may include executable code that performs one or more specific functions. The main system resource may call each function resource when the function implemented by each such specific function resource is needed.

As described above, in some examples, resources 135 have unique physical addresses (e.g., in memory 130) within a physical address space, which may be set during the boot of IC 100. However, processor 110 generates logical addresses during execution of the resources. For example, when an instruction in one resource 135 issues a call to another resource 135, the calling instruction issues the call to a logical address associated with the function resource being called. After the called function resource completes its execution, execution may jump back to the calling resource using a logical address associated with the next instruction to be executed. Memory mapper 120 receives logical addresses from processor 110, for example, through the address bus 112. Memory mapper 120 converts a logical address to a physical address and uses the physical address to access the called resource at its physical address in memory 130.

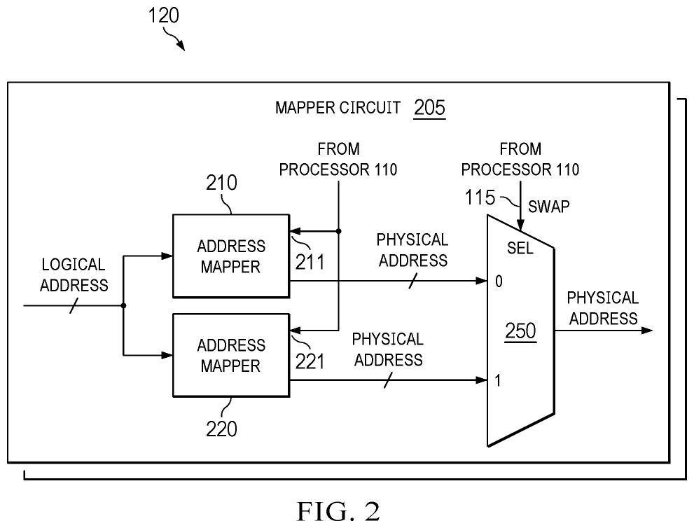

FIG. 2 is a schematic diagram of an example memory mapper 120. In this example, memory mapper 120 includes one or more mapper circuits 205. Each mapper circuit 205 includes address mappers 210 and 220 and selection logic (e.g., a, multiplexer) 250. Although two address mappers 210 and 220 are shown in FIG. 2, each mapper circuit 205 can include more than two address mappers in other examples. Each address mapper 210 and 220 has an input that receives a logical address and converts the logical address to a physical address. The selection logic 250 includes a first input (“0”) and a second input (“1”). The output of address mapper 210 is coupled to the 0 input of selection logic 250, and the output of address mapper 220 is coupled to the 1 input. Based on the SWAP signal 115 (e.g., at SWAP output 114 or stored in an internal register of memory mapper 120), the selection logic 250 provides either the physical address at its 0 input (e.g., when the SWAP signal 115 is deasserted) to its output or the physical address at its 1 input (e.g., when the SWAP signal 115 is asserted) to its output as the output physical address from memory mapper 120.

In some examples, each address mapper 210, 220 has a configuration input. Address mapper 210 has a configuration input 211, and address mapper 220 has a configuration input 221. Processor 110 may provide separate logical-to-physical address mapping configuration data to the configuration input of each address mapper. The logical-to-physical address mapping configuration data may include the logical address of the first address in a particular logical address space and the physical address of the first instruction in a particular physical address space. The logical-to-physical address mapping configuration data may be provided by processor 110 by way of the data and address busses 111 and 112, or by way of control signals independent of the busses 111 and 112. The logical-to-physical address mapping configuration data configures each address mapper 210 and 220 to convert a given input logical address to a particular physical address.

In some examples, address mappers 210 and 220 may be configured to convert the same logical address to two different physical addresses. That is, address mapper 210 can be configured to convert a particular logical address to a first physical address, and address mapper 220 can be configured to convert the same logical address to a second physical address. By being able to convert the same logical address to two different physical addresses, system 105 can switch execution from executing a first resource 135 stored or accessible at a first physical address space and accessible via a first logical space to a second resource 135 stored or accessible at a second physical address space while continuing to use the same logical address space.

With multiple mapper circuits 205, multiple logical address spaces can be separately converted to different physical address spaces. Such an architecture permits multiple resources, each with its own logical address, to be mapped to a unique physical address space and then be remapped to a different physical address space, e.g., if a resource is to be upgraded or duplicated.

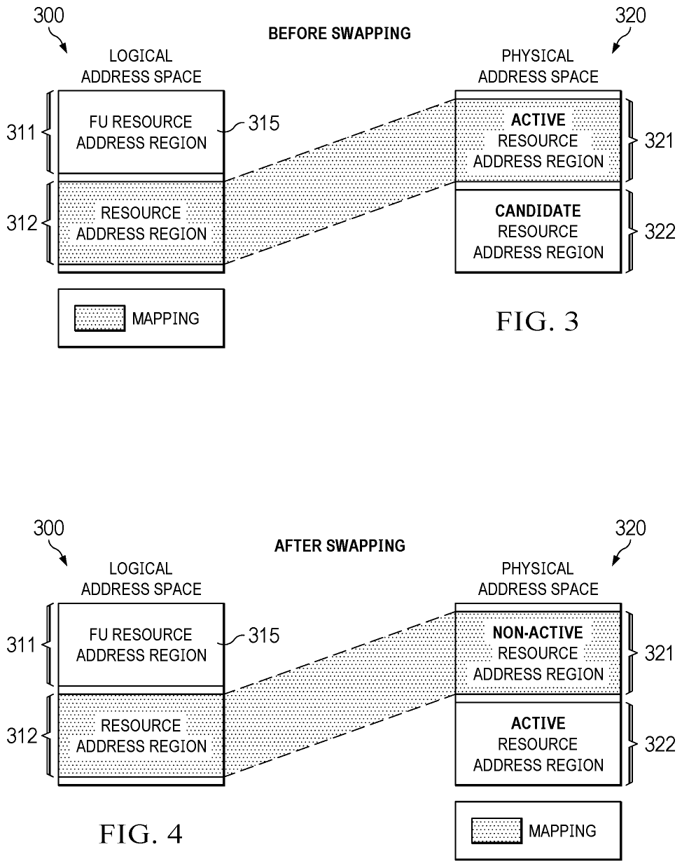

FIGS. 3 and 4 are diagrams that illustrate an example process for switching execution from a first resource to a second resource while maintaining use of the same logical address space. FIG. 3 includes a memory map 300 corresponding to the logical address space and a memory map 320 corresponding to the physical address space. Resources 135 (e.g., stored in memory 130) accessible via the logical address space include logical address regions 311 and 312. A firmware update resource 315 (described below) may be stored at a physical address region (not specifically shown, such as in memory 130) and accessible via logical address region 311. Logical address region 312 corresponds to a resource that can be updated (or switched over to a duplicate copy of the resource), which may include multiple executable instructions whose logical addresses may be contiguous across the resource address region 312. Memory mapper 120 has been configured to convert the logical address region 312 corresponding to the resource to be updated to a physical address region 321 at which the resource is actually stored in memory 120. The resource stored in the physical address space 321 is the currently executing version of the resource (the active resource).

Physical address region 322 may include the candidate resource. As described above, the candidate resource may be an updated version or an identical copy of the active resource stored in the physical address region 321. The firmware update resource 315 may include code that, when executed by processor 110 and as described below, configures memory mapper 120 to switch the mapping of the logical address space 312 from the physical address space 321 to the physical address space 322. The processor 110 then continues executing the candidate resource (now the active resource) from the physical address space 322 but does so using the same logical address space 312.

FIG. 4 illustrates the logical-to-physical address mapping after memory mapper 120 is configured to switch over to the candidate resource. As shown in FIG. 4, the same logical address space 312 is now mapped to the physical address space 322 instead of to the physical address space 321 and the resource in physical address space 322 became the active resource. The resource in physical address space 321 is no longer the active resource.

The configuration of address mapper 220 to convert logical address space 312 to physical address space 322 may occur before or while processor 110 is actively accessing the resource accessed by logical address space 312. Then, to switch the mapping of the logical address space 312 to the physical address space 322, processor 110 asserts the SWAP signal 115 (FIG. 1) to the appropriate logic level to cause selection logic 250 to provide the physical address at its “1” input to its output. In some examples, the change in logic state of the SWAP signal 115 and the resulting change in the selection logic 250 to provide the physical address at its “1” input to its output may occur in less than one clock cycle (or by otherwise ensuring the logical address being swapped is not accessed during the swapping operation), thereby resulting in a “live” resource update, that is, switching over from one resource to another without a cessation in operation of the executable resources and without needing a reset of processor 110.

Because the logical address space is preserved after the remapping from one physical address space to another physical address, the privileged (e.g., secure) and non-privileged (e.g., non-secure) configurations, global and static variables, local variables, pointers, global and static pointers, function pointers, etc., there is no need for a system restart. Accordingly, a cold start, warm start, or reset of the system or a subsystem, is not needed.

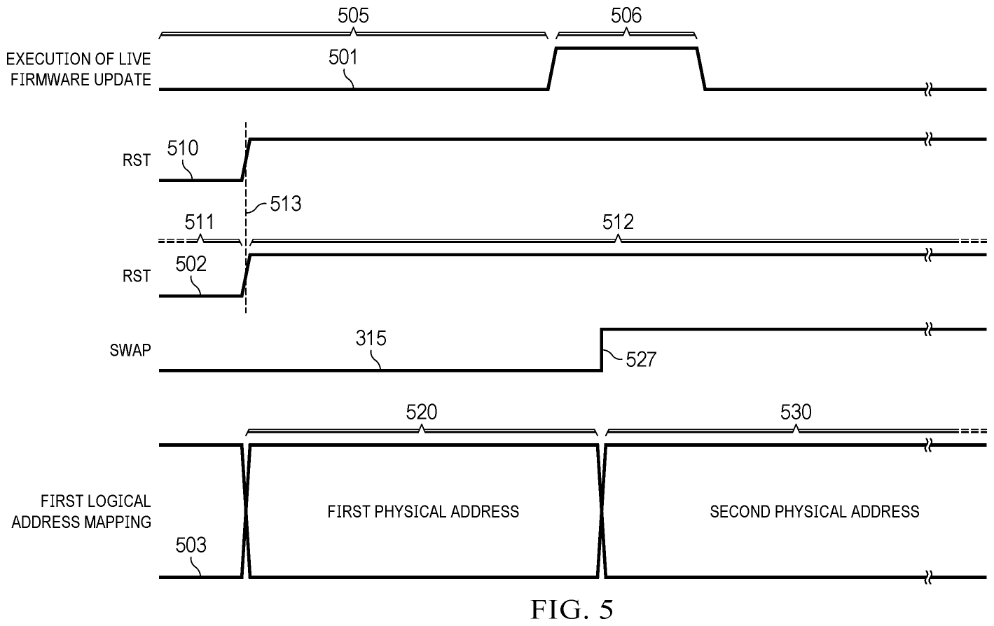

FIG. 5 is a timing diagram illustrating the switch-over of execution of a first resource to a second resource. The first resource is stored in memory 130 at a first physical address. The second resource is stored in memory 130 at a second physical address. The timing diagram of FIG. 5 includes a waveform 501 indicative of whether the firmware update resource 315 is executing, a system reset signal 510, a device reset signal 502, a waveform 503 indicative of whether the logical address of the first or second resource is actively mapped to the corresponding physical address of the first or second resource, and an example waveform for SWAP signal 315. In this example, waveform 501 being logic low at 505 indicates that the firmware update resource 315 is not being executed, and the logic high state 506 of waveform 501 indicates that the firmware update resource 315 is being executed by processor 110.

The system reset signal 510 is the reset signal provided to the RST input 107 of system 105. The device reset signal is the reset signal provided to the RST input 113 of processor 110. The reset signals 510 and 502 may be generated by, for example, a power-on reset circuit, an interrupt, etc. During time period 511, reset signals 502 and 510 are held logic low forcing processor 110 and system 105 to be in their respective reset states. While system 105 and/or processor 110 is in the reset state, processor 110 is unable to access any of resources 135. At rising edge 513, the RST signal 502 transitions to a logic high state thereby discontinuing the reset state for the processor during time period 512.

Before the firmware update resource 315 is executed, with the SWAP signal 315 at a first level (e.g., logic low), the logic address space for the first resource is mapped by memory mapper 120 to a first physical address, as indicated at 520. The processor 110 then executes the firmware update resource 315 as indicated by waveform 501 being logic high 506. Firmware update resource 315 remaps the logical address by which the first resource was being accessed to the physical address at which the second resource is stored, as indicated at 530. In some examples, firmware update resource 315 causes the SWAP signal 315 to change logic states (e.g., from logic low to logic high) at 527 to cause the selection logic 250 to change use between mappers 210 and 220, as described above. Any resource in system 105 that had been using the logical address to access (e.g., call) the first resource can then continue using the same logical address to access the second resource.

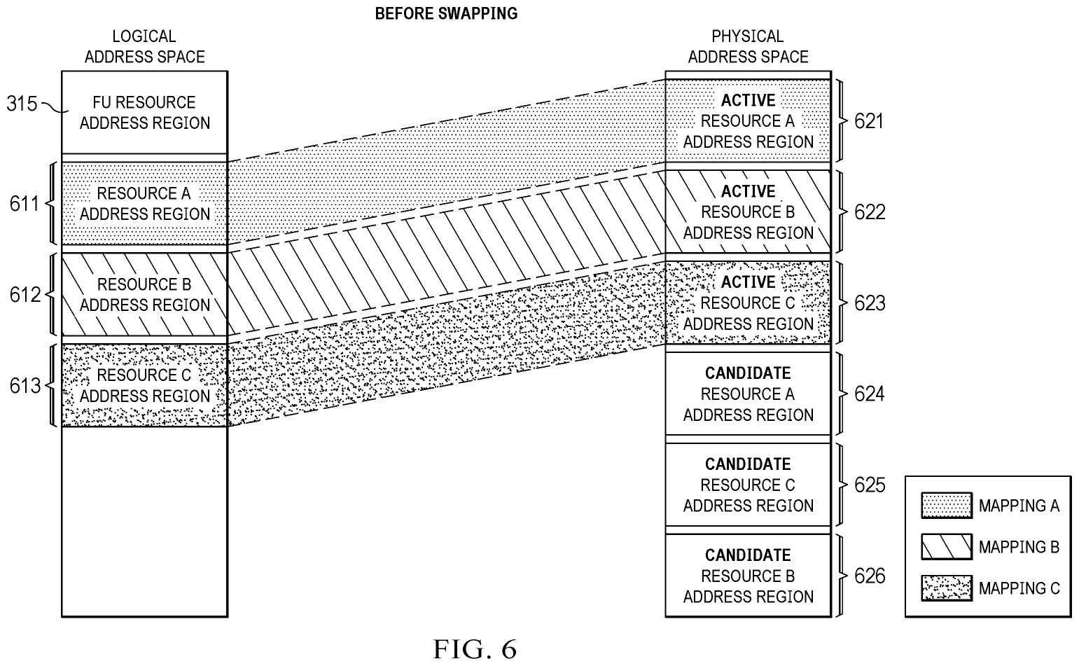

FIG. 6 is an example logic-to-physical address mapping of active resources A, B, and C from their respective logical address spaces 611, 612, and 613 to current physical address spaces 621, 622, and 623. The logical address spaces 611-613 need not all be contiguous as shown in the example of FIG. 6. As shown in FIG. 6, logical address space 611 is mapped to physical address space 621; logical address space 612 is mapped to physical address space 622; and logical address space 613 is mapped to physical address space 623. Physical address spaces 621-623 may or may not be contiguous. In this example, physical address spaces 622 and 623 are contiguous and physical address space is not contiguous with either physical address spaces 621 or 622. The active resources A, B, and C are the resources stored in or accessed at physical address spaces 621-623, respectively, which are mapped to logical address spaces 611-613 as shown in FIG. 6. Physical address spaces 624, 625, and 626 may contain candidate resources A, B, and C, respectively.

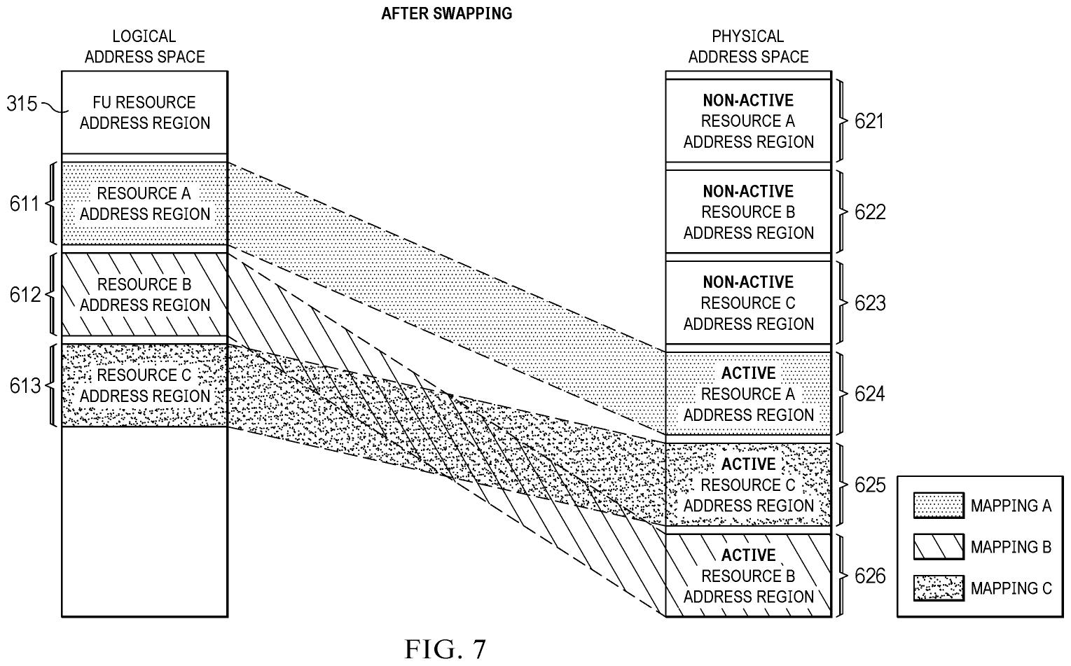

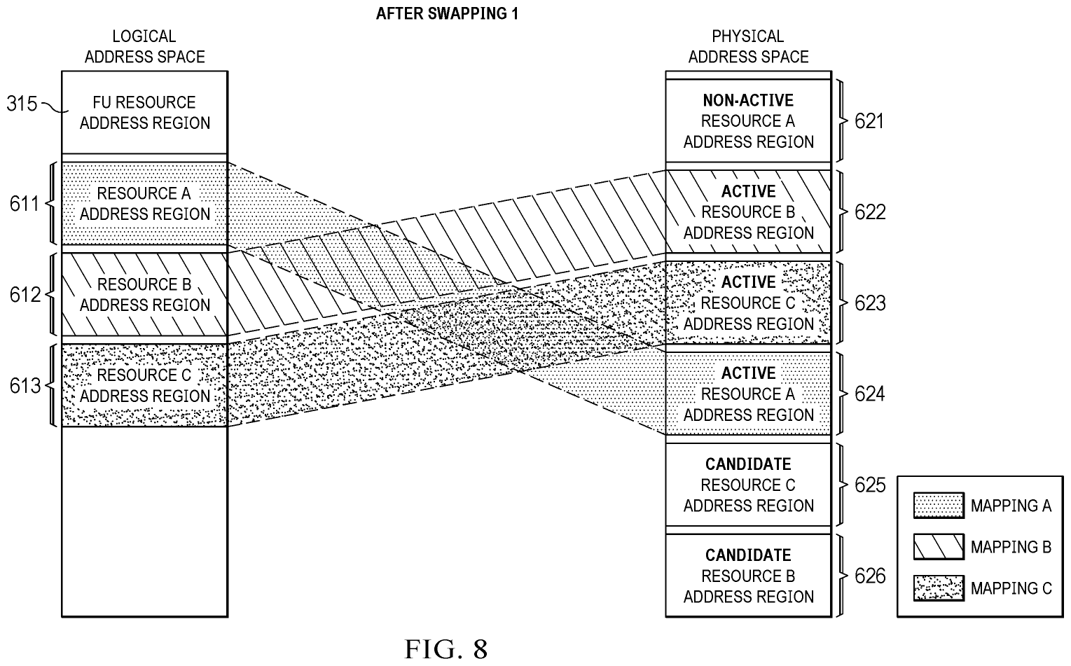

Processor 110 may configure memory mapper 120 to remap logical address spaces 611, 612, and 613 to physical address spaces 624, 626, and 625, respectively to thereby cause the candidate resources A-C to be executed. FIG. 7 includes the logical-to-physical address mapping of the logical address spaces 611, 612, and 613 to the corresponding physical address spaces 624, 626, and 625 after memory mapper 120 is reconfigured. As shown in FIG. 7, after the remapping operation, former candidate resources A-C at physical address spaces 624, 626, and 624 are shown as “active” resources A-C, and the previous active resources A-C at physical address spaces 621-623 are now “non-active” resources.

As described above regarding FIG. 2, memory mapper 120 may have multiple mapper circuits 205 to permit each of multiple logical address spaces to be converted to (e.g., two) different physical address spaces. Before processor 110 executes or accesses resources A-C from physical address spaces 621-623, processor 110 may configure the address mappers (e.g., address mappers 210 in respective mapper circuits 205 of memory mapper 120 to convert logical address spaces 611-613 to physical address spaces 621-623. Before or while processor 110 is executing or accessing resources A-C, processor 110 may configure other address mappers (e.g., address mappers 220) in the respective mapper circuits 205 to convert logical address spaces 611-613 to physical address spaces 624, 626, and 625. Then, to switch the mapping of the logical address spaces 611-613 to the physical address space 624, 626, and 625, processor 110 asserts the SWAP signal 115 to the appropriate logic level to cause the selection logic 250 of mapper circuits 205 to switch between their inputs to provide physical address at their outputs. As described above, in some examples, the change in logic state of the SWAP signal 115 and the resulting change in each selection logic 250 to switch use of its inputs may occur in less than one clock cycle (or within a period of time in which the respective resource is not accessed).

FIGS. 6 and 7 illustrate remapping of logical address spaces 611-613 in parallel, e.g., in one clock cycle, from physical address spaces 621-623 to physical address spaces 624, 626, and 625. FIGS. 8-10 illustrate the same logical-to-physical address remapping but performed in a sequential fashion in which the mapper circuits 205 of each of the three logical address spaces 611-613 are sequentially reconfigured. In FIG. 6 and as described above, memory mapper 120 has been configured to map logical address spaces 611-613 to physical address spaces 621-623. Before or while processor 110 is executing resource A from physical address space 621, processor 110 reconfigures memory mapper 120 so that an address mapper 220 in a mapper circuit 205 associated with logical address space 611 maps logical address space 611 to physical address space 624. Processor 110 then asserts the SWAP signal 115 to cause the multiplexer 250 coupled to that particular address mapper to switch to the input that receives the physical addresses for physical address space 624. FIG. 8 illustrates that logical address space 611 has been remapped to physical address space 624 while logical address spaces 612 and 613 remain mapped to physical address spaces 622 and 623, respectively. Switching from physical address space 621 to physical address space 624 for logical address space 611 may occur within one clock cycle, as described above.

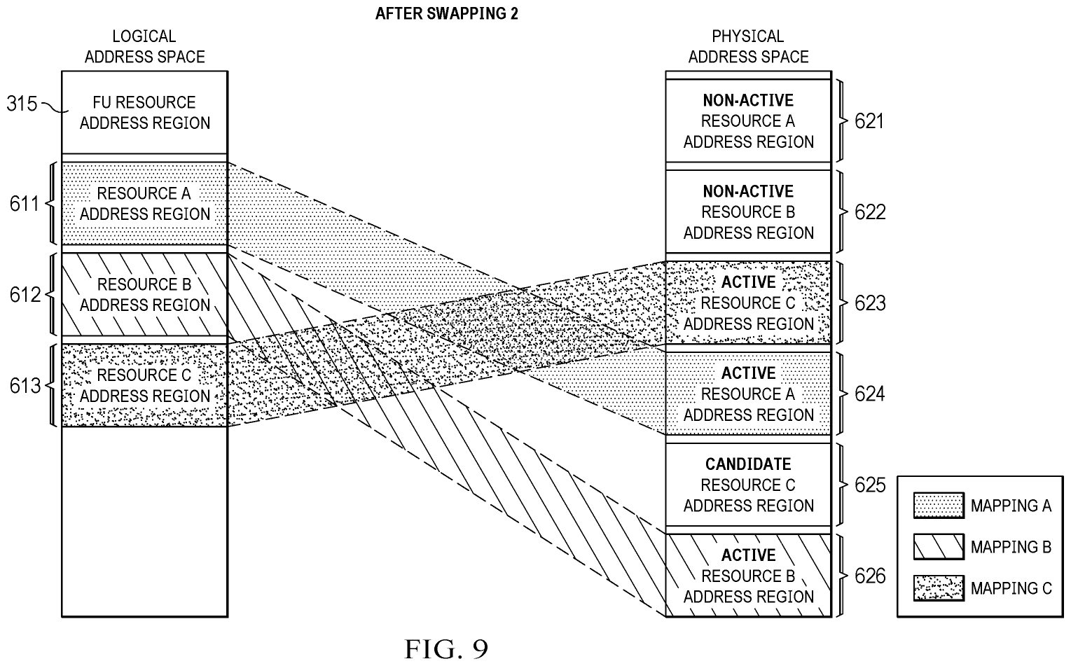

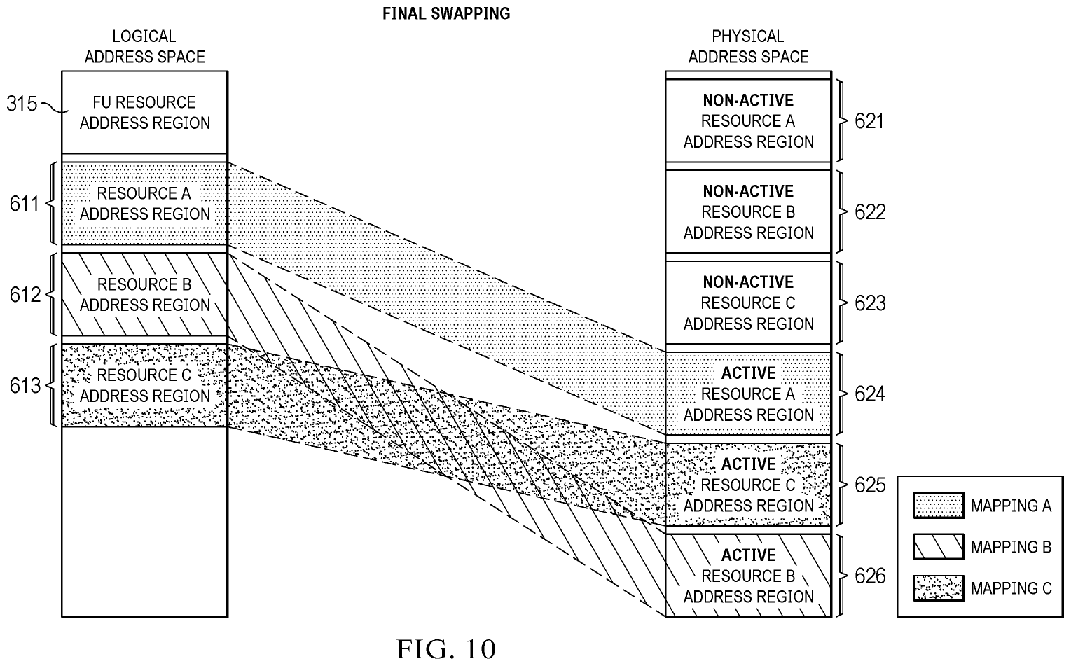

This process is sequentially repeated to remap logical address spaces 612 and 613. FIG. 9 illustrates that logical address space 612 has been remapped (e.g., in one clock cycle) from physical address space 622 to physical address space 626, while logical address space 613 remains mapped to physical address space 623. Processor 110 may have reconfigured the address mapper of the mapper circuit 205 associated with logical address space 612 before or while processor 110 executes resource B. FIG. 10 illustrates that logical address space 613 has been remapped from physical address space 623 to physical address space 625.

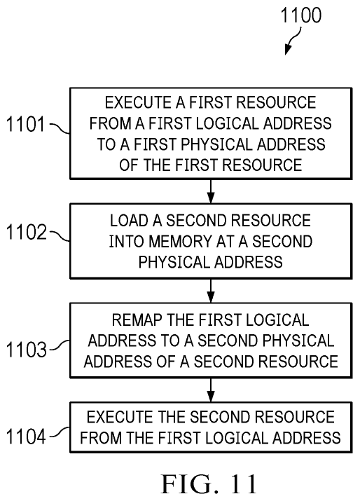

FIG. 11 is a flow chart showing an example method 1100 for switching over from execution of a first resource (e.g., located at physical address region 321) to a second resource (e.g., located at physical address region 322). For example, method 1100 may be performed to implement the examples of FIGS. 3-4 and/or FIGS. 6-7. In one example, the first and second resources are identical copies of each other and thus have the same size, which may provide redundancy. Such redundancy may be advantageous if, for example, one or more instructions of the active resources becomes corrupted. In another example, the first and second resources are not identical and thus may have different sizes. For example, the second resource may be an upgraded version of the first resource, generally performing the same function but with upgrades, e.g., that address bugs in the code of the first resource, improve the performance of the second resource relative to the first resources, etc. In some examples, the first resource is stored in memory 135 at a first physical address or is accessible at the first physical address. The first resource is accessible (e.g., executed) using a first logical address, which is mapped to the first physical address by memory mapper 120.

At step 1101, method 110 includes executing, for example by processor 110, the first resource from its first logical address, which is mapped to a first physical address of memory 135. At step 1102, the method includes loading the second resource into memory 135 at a second physical address. In other examples, the second resource may have already been loaded into memory, for example, before method 1100 is performed (e.g., loaded into read-only memory (ROM) during manufacturing). In some examples, the memory mapper (e.g., 120) may be reconfigured during step 1102. Then, at step 1103, while executing a firmware update resource by processor 110, the method includes remapping the first logical address to the second physical address. For example, in some examples, SWAP signal 115 is asserted during step 1103. In some examples, the memory mapper may be reconfigured during step 1103. At step 1104, the method includes executing, by the processor, the second resource from the first logical address.

In some examples, before a candidate resource is made available for execution to processor 110 (e.g., before SWAP signal 115 is asserted), e.g., as a result of the resource update process (e.g., 1100) described herein, processor 110 may perform one or more checks on the candidate resources. Such checks may include any combination of, for example, authenticating the source of the candidate resource, validating the integrity of the candidate resource, or functionally validating the candidate resource. If any such check fails, system 105 can decline to switch-over from the currently executing resource to the candidate resource and possibly report an error. Otherwise, if all such checks pass, system 105 can remap the logical address space of the active resource to the physical address space at which the candidate resource is stored or accessible (e.g., by asserting SWAP signal 115).

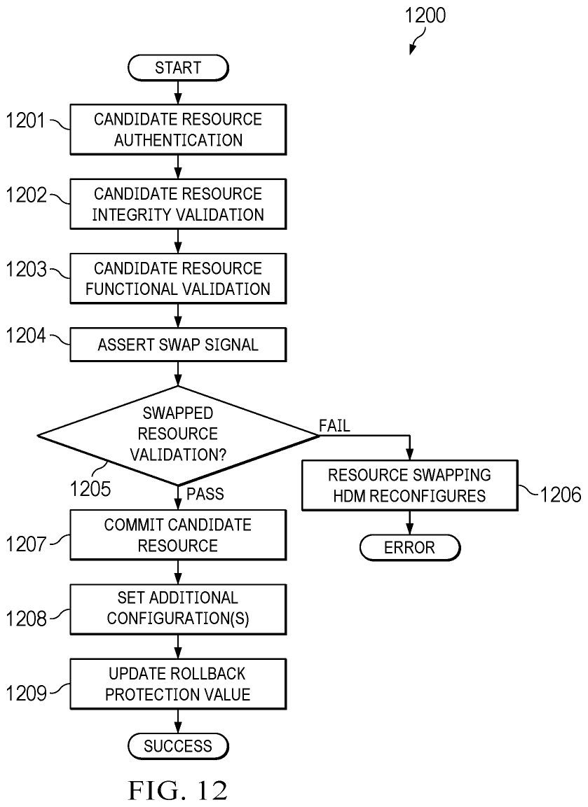

FIG. 12 is a flow chart showing an example method 1200 which includes one or more checks on the candidate resource. For example, method 1200 may be performed to implement the examples of FIGS. 3-4 and/or FIGS. 6-7. Before the active resource's logical address space is remapped to the physical address space at which the candidate resource is stored, checks at steps 1201-1203 may be performed on the candidate resource. The checks of steps 1201-1203 may be performed in the order shown or in a different order. One or more of the checks of steps 1201-1203 may be performed at any time before remapping the logical address space of the active resource to the candidate resource's physical address space. In some examples, any of the checks of steps 1201-1203 may be performed by the processor executing a resource (e.g., an authentication or validation resource) at its own logical address to check the candidate resource. For example, the candidate resource may be loaded into memory 135 an hour, a week, a month, a year, etc. before the system 105 switches from the active resource to the previously loaded candidate resource or the candidate resource may have been preloaded into memory from the factory (e.g., may be stored in ROM). In some examples, one or more checks of steps 1201-1203 may be performed when the candidate resource is loaded into memory 135 and thus a relatively long time before switching over from execution of the active resource to the candidate resource. In some examples, one or more checks 1201-1203 may be performed during execution of a firmware update resource (e.g., during period of time 506).

In some examples, a resource stored in memory 135 may be executed by processor 110 to perform the checks of steps 1201-1203.

In step 1201, processor 110 authenticates the candidate resource. The authentication process may include, for example, using digital certificates and digital signatures to confirm that the digital “signer” of the candidate resource is correct. In some examples, the authentication process may include calculating a hash of the candidate resource and comparing the calculated hash to a digital signature.

In step 1202, processor 110 performs an integrity validation on the candidate resource, which ensures that all of the bits of the candidate resource are present and have not been corrupted. The integrity validation process may include, for example, calculating a checksum and comparing the calculate checksum to a known checksum value, calculating a cyclic redundancy check (CRC) code, etc.

In step 1203, processor 110 performs a functional validation on the candidate resource, which tests whether the candidate resource functions as intended. In one example, the candidate resource may be executed by processor 110 using test data for which the output values from a correctly executing candidate resource are known. The results of the execution of the candidate resource using the test data can be compared to the known results. If the results match, then the candidate resources passes the functional validation. If any of the checks of steps 1201-1203 fail, the process for updating the active resource to the candidate resource may terminate without a switch-over to the candidate resource (e.g., without asserting SWAP signal 115).

Additional or different checks that may be performed before step 1204 is performed includes rollback prevention (described below regarding step 1209), validating the versions of firmware and hardware, and validating the format of the candidate resource (e.g., confirming that all functions are present for the candidate resource based on a manifest).

At step 1204, as described above, processor 110 executes the firmware update resource 315, which may reconfigure memory mapper 120 to switch-over the mapping between the logical address space of the active resource's physical address space to the candidate resource's physical address space. Step 1204 may include the processor 110 asserting the SWAP signal 115 to cause memory mapper 120 to begin using the candidate resource's logical-to-physical address mapping. In some examples, the processor 110 may have previously configured (e.g., before step 1204) the address mapper 210, 220 of memory mapper 120 with the information needed to convert the logical address space to the corresponding physical address space of the candidate resource. Alternatively, step 1205 can include processor 110 configuring the address mapper of memory mapper 120 with the information needed to convert the logical address space to the corresponding physical address space of the candidate resource.

Step 1205 includes performing one or more (e.g., additional) validation checks on the candidate resource before it is committed for use. The validation checks in step 1205 can include one or more of the checks (e.g., similar or identical) of steps 1201-1203, described above. If any validation check(s) in step 1205 fails, then control passes to step 1206 in which the processor 110 again executes the firmware update resource 315 to switch the logical-to-physical address mapping back to the physical address of the active resource. For example, during step 1206, the firmware update resource 315 may deassert the SWAP signal 115 to cause the selection logic 250 to change the logical-to-physical address mapping back to the former mapping which was implemented before step 1204 was performed.

If the validation check(s) in step 1205 passes, then steps 1207-1209 are performed, e.g., in the order shown or in a different order. In step 1207, processor 110 commits the candidate resource to be the new active resource to allow for its access by processor 110. Committing the candidate resource may include setting a status bit in a register, e.g., to indicate that the new active resource has been successfully installed and, e.g., can run feely. For example, in some examples, the new active resource can run in a reduced functionality mode (e.g., safe mode) before step 1207 is performed. After step 1207 is performed, the new active resource can run in normal (e.g., full functionality) mode.

Processor 110 may set one or more additional configurations in step 1208, such as firewall and security configurations, hardware accelerator activation, new configuration associated with new functionality introduced by the new active resource, etc.

In step 1209, processor 110 may update (e.g., increment) a rollback protection value. In some examples, each version of a resource may have, for example, a unique index number. The rollback protection value prevents processor 110 from switching back to a previous version of a resource whose index number is less than the current rollback protection value. By updating the rollback protection value in step 1209, firmware update resource 315 may not be able to switch the logical-to-physical address mapping of the new active resource to the former version of resource. Another check that can be included before step 1204 is performed is rollback prevention in which the candidate's index number is compared to the rollback prevention value. If the candidate's index number is inconsistent with the rollback prevention value (e.g., is less than the rollback prevention value), the processor 110 may deny a change-over to the candidate resource.

Example embodiments of the present disclosure are summarized here. Other embodiments can also be understood from the entirety of the specification and the claims filed herein.

Example 1. A system, including: memory including a first resource at a first physical address space that includes a first physical address, and a second resource at a second physical address space that includes a second physical address; a memory mapper coupled to the memory, the memory mapper configured to convert logical addresses to physical addresses; and a processor coupled to the memory mapper, the processor configured to: execute the first resource from a first logical address mapped by the memory mapper to the first physical address; while executing a firmware update resource, remap the first logical address to the second physical address using the memory mapper; and execute the second resource from the first logical address.

Example 2. The system of example 1, where the memory further includes the firmware update resource at a third physical address.

Example 3. The system of one of examples 1 or 2, where the processor is configured to perform an authentication of the second resource before remapping the first logical address to the second physical address.

Example 4. The system of one of examples 1 to 3, where the processor is configured to perform an integrity validation of the second resource before remapping the first logical address to the second physical address.

Example 5. The system of one of examples 1 to 4, where the processor is configured to perform a functional validation of the second resource before remapping the first logical address to the second physical address.

Example 6. The system of one of examples 1 to 5, where the processor is configured to: before remapping the first logical address to the second physical address, execute a validation resource at a second logical address to perform the functional validation of the second resource at the second physical address; and in response to a successful functional validation of the second resource, remap the first logical address to the second physical address.

Example 7. The system of one of examples 1 to 6, where the processor is configured to remap the first logical address from the second physical address back to the first physical address in response to a fault during execution of the second resource.

Example 8. The system of one of examples 1 to 7, where the processor is configured to cause freeing of memory locations associated with the first resource after remapping the first logic address to the second physical address.

Example 9. The system of one of examples 1 to 8, where the first physical address corresponds to a first instruction of the first resource, and the second physical address corresponds to a first instruction of the second resource.

Example 10. The system of one of examples 1 to 9, where a size of the first physical address space is different from a size of the second physical address space.

Example 11. The system of one of examples 1 to 10, where the second resource is a duplicate of the first resource.

Example 12. The system of one of examples 1 to 11, where the processor includes a reset input, where the processor is configured to reset responsive to an assertion of the reset input, and where the processor is configured to remap the first logical address to the second physical address and use the second resource while the reset input remains deasserted.

Example 13. The system of one of examples 1 to 12, where the processor is configured to execute instructions based on a clock, and where the processor is configured to remap the first logic address to the second physical address within 1 clock cycle of the clock.

Example 14. The system of one of examples 1 to 13, where the processor is configured to load the second resource into the second physical address space.

Example 15. The system of one of examples 1 to 14, where the memory includes a read-only memory storing the second resource at the second physical address space.

Example 16. The system of one of examples 1 to 15, where the processor is configured to remap the first logical address to the second physical address by: providing the second physical address to the memory mapper; and asserting a swap signal to cause the memory mapper to select a conversion of the first logical address to the second physical address instead of a conversion of the first logical address to the first physical address.

Example 17. An integrated circuit (IC), including: a memory mapper configured to convert logical addresses to physical addresses; and a processor coupled to the memory mapper, the processor configured to: execute a first resource from a first logical address mapped by the memory mapper to a first physical address of a memory; while executing a firmware update resource, remap the first logical address to a second physical address of a second resource using the memory mapper; and execute the second resource from the first logical address.

Example 18. The IC of example 17, where the IC includes the memory coupled to the memory mapper.

Example 19. The IC of one of examples 17 or 18, where the processor is configured to perform an authentication, an integrity validation, or a functional validation of the second resource before remapping the first logical address to the second physical address.

Example 20. The IC of one of examples 17 to 19, where the processor is configured to: perform an authentication, an integrity validation, or a functional validation of the second resource after configuring the memory mapper to remap the first logical address to the second physical address; while executing the firmware update resource, remap the first logical address back to the first physical address in response to a fault of the authentication, integrity validation, or functional validation of the second resource; and execute the first resource from the first logical address.

Example 21. The IC of one of examples 17 to 20, where, in response to a success of the authentication, integrity validation, or functional validation of the second resource, the processor is configured to change a rollback protection value.

Example 22. The IC of one of examples 17 to 21, where the processor includes a reset input, where the processor is configured to reset responsive to an assertion of the reset input, and where the processor is configured to remap the first logical address to the second physical address while the reset input of the processor remains deasserted.

Example 23. The IC of one of examples 17 to 22, where the IC further includes a reset input, and where the processor is configured to remap the first logical address to the second physical address while the reset input of the IC remains deasserted.

Example 24. A method, including: executing, by a processor, a first resource from a first logical address mapped to a first physical address of a memory; while executing a firmware update resource by the processor, remapping the first logical address to a second physical address of the memory; and executing, by the processor, a second resource from the first logical address.

Example 25. The method of example 24, further executing, by the processor, a third resource that performs an authentication, an integrity validation, or a functional validation of the second resource before remapping the first logical address to the second physical address.

Example 26. The method of one of examples 24 or 25, further including: executing, by the processor, a third resource that performs an authentication, an integrity validation, or a functional validation of the second resource after remapping the first logical address to the second physical address; while executing the firmware update resource by the processor, remapping the first logical address back to the first physical address in response to a fault of the authentication, integrity validation, or functional validation of the second resource; and executing, by the processor, the first resource from the first logical address.

Example 27. The method of one of examples 24 to 26, where remapping the first logic address to the second physical address occurs within 1 clock cycle of a clock of the processor.

While certain elements of the described examples are included in an integrated circuit and other elements are external to the integrated circuit, in other example embodiments, additional or fewer features may be incorporated into the integrated circuit.

Modifications are possible in the described embodiments, and other embodiments are possible, within the scope of the claims.

What is claimed is:

1. A system, comprising:
memory including a first resource at a first physical address space that includes a first physical address, and a second resource at a second physical address space that includes a second physical address;
a memory mapper coupled to the memory, the memory mapper configured to convert logical addresses to physical addresses; and
a processor coupled to the memory mapper, the processor configured to:
execute the first resource from a first logical address mapped by the memory mapper to the first physical address;
while executing a firmware update resource, remap the first logical address to the second physical address using the memory mapper; and
execute the second resource from the first logical address.

2. The system of claim 1, wherein the memory further includes the firmware update resource at a third physical address.

3. The system of claim 1, wherein the processor is configured to perform an authentication of the second resource before remapping the first logical address to the second physical address.

4. The system of claim 1, wherein the processor is configured to perform an integrity validation of the second resource before remapping the first logical address to the second physical address.

5. The system of claim 1, wherein the processor is configured to perform a functional validation of the second resource before remapping the first logical address to the second physical address.

6. The system of claim 5, wherein the processor is configured to:
before remapping the first logical address to the second physical address, execute a validation resource at a second logical address to perform the functional validation of the second resource at the second physical address; and
in response to a successful functional validation of the second resource, remap the first logical address to the second physical address.

7. The system of claim 1, wherein the processor is configured to remap the first logical address from the second physical address back to the first physical address in response to a fault during execution of the second resource.

8. The system of claim 1, wherein the processor is configured to cause freeing of memory locations associated with the first resource after remapping the first logic address to the second physical address.

9. The system of claim 1, wherein the first physical address corresponds to a first instruction of the first resource, and the second physical address corresponds to a first instruction of the second resource.

10. The system of claim 1, wherein a size of the first physical address space is different from a size of the second physical address space.

11. The system of claim 1, wherein the second resource is a duplicate of the first resource.

12. The system of claim 1, wherein the processor includes a reset input, wherein the processor is configured to reset responsive to an assertion of the reset input, and wherein the processor is configured to remap the first logical address to the second physical address and use the second resource while the reset input of the processor remains deasserted.

13. The system of claim 1, wherein the processor is configured to execute instructions based on a clock, and wherein the processor is configured to remap the first logic address to the second physical address within 1 clock cycle of the clock.

14. The system of claim 1, wherein the processor is configured to load the second resource into the second physical address space.

15. The system of claim 1, wherein the memory includes a read-only memory storing the second resource at the second physical address space.

16. The system of claim 1 wherein the processor is configured to remap the first logical address to the second physical address by:
providing the second physical address to the memory mapper; and
asserting a swap signal to cause the memory mapper to select a conversion of the first logical address to the second physical address instead of a conversion of the first logical address to the first physical address.

17. An integrated circuit (IC), comprising:
a memory mapper configured to convert logical addresses to physical addresses; and
a processor coupled to the memory mapper, the processor configured to:
execute a first resource from a first logical address mapped by the memory mapper to a first physical address of a memory;
while executing a firmware update resource, remap the first logical address to a second physical address of a second resource using the memory mapper; and
execute the second resource from the first logical address.

18. The IC of claim 17, wherein the IC comprises the memory coupled to the memory mapper.

19. The IC of claim 17, wherein the processor is configured to perform an authentication, an integrity validation, or a functional validation of the second resource before remapping the first logical address to the second physical address.

20. The IC of claim 17, wherein the processor is configured to:
perform an authentication, an integrity validation, or a functional validation of the second resource after configuring the memory mapper to remap the first logical address to the second physical address;
while executing the firmware update resource, remap the first logical address back to the first physical address in response to a fault of the authentication, integrity validation, or functional validation of the second resource; and
execute the first resource from the first logical address.

21. The IC of claim 20, wherein, in response to a success of the authentication, integrity validation, or functional validation of the second resource, the processor is configured to change a rollback protection value.

22. The IC of claim 17, wherein the processor includes a reset input, wherein the processor is configured to reset responsive to an assertion of the reset input, and wherein the processor is configured to remap the first logical address to the second physical address while the reset input of the processor remains deasserted.

23. The IC of claim 22, wherein the IC further includes a reset input, and wherein the processor is configured to remap the first logical address to the second physical address while the reset input of the IC remains deasserted.

24. A method, comprising:
executing, by a processor, a first resource from a first logical address mapped to a first physical address of a memory;
while executing a firmware update resource by the processor, remapping the first logical address to a second physical address of the memory; and
executing, by the processor, a second resource from the first logical address.

25. The method of claim 24, further executing, by the processor, a third resource that performs an authentication, an integrity validation, or a functional validation of the second resource before remapping the first logical address to the second physical address.

26. The method of claim 24, further comprising:
executing, by the processor, a third resource that performs an authentication, an integrity validation, or a functional validation of the second resource after remapping the first logical address to the second physical address;
while executing the firmware update resource by the processor, remapping the first logical address back to the first physical address in response to a fault of the authentication, integrity validation, or functional validation of the second resource; and
executing, by the processor, the first resource from the first logical address.

27. The method of claim 24, wherein remapping the first logic address to the second physical address occurs within 1 clock cycle of a clock of the processor.
